(19) United States
(12) Patent Application Publication
(10) Pub. No.: US 2026/0139872 A1
(43) Pub. Date: May 21, 2026

(54) LIQUID HEATING DEVICE

(71) Applicant: Niterra Co., Ltd., Nagoya-shi, Aichi (JP)

(72) Inventors: Yusuke MAKINO, Nagoya-shi, Aichi (JP); Yuya HIGASHIDE, Nagoya-shi, Aichi (JP)

(73) Assignee: Niterra Co., Ltd., Nagoya-shi, Aichi (JP)

(21) Appl. No.: 18/705,780

(22) PCT Filed: Oct. 31, 2022
(86) PCT No.: PCT/JP2022/040637

§ 371 Date: Apr. 29, 2024

(30) Foreign Application Priority Data
Apr. 22, 2022 (JP) 2022-070578

(51) Int. Cl. F24H 1/10; H05B 3/48

(52) U.S. Cl. CPC F24H 1/102; H05B 3/48; F24H 2250/02; H05B 2203/016

(57) ABSTRACT

A liquid heating device (300) including a container (100); three or more ceramic heaters (171-173) extend in a front-rear direction AX and a pair of heater terminals (18a, 18b) at base-end portion (17R); and a separator (240) opposed to the container and having a retention portion (242a-246a, 242b-246b) surrounding at least a part of each heater terminal of the pairs of heater terminals, to restrict positions of the heater terminals, wherein the ceramic heaters are arranged side by side with each other along the front-rear direction, and in a cross-section crossing the front-rear direction, centers of gravity (G1-G3) of a plurality of the ceramic heaters are respectively located at vertices of a polygon (PL), a first heater terminal (18a) which is one of the pair of heater terminals of each ceramic heater is located inside the polygon, and a second heater terminal (18b) is located outside the polygon.

### TECHNICAL FIELD

The present invention relates to a liquid heating device suitable for heating a liquid such as water.

### BACKGROUND ART

Warm water is needed for a warm water washing toilet seat, a fuel cell system, a water heater, a 24-hour bath system, heating of a washer fluid for a vehicle, an in-vehicle air conditioner, and the like. Accordingly, a liquid heating device which heats water by a built-in heater is used.

In particular, for the purpose of rapid heating or the like, a heater having a high watt density is needed and therefore a rod-shaped ceramic heater having a heat generation portion embedded in a ceramic sheet wrapped around the outer circumference of an elongated ceramic base is used (Patent Document 1).

This ceramic heater has a pair of heater terminals at a base-end portion and current is applied between the heater terminals, thereby energizing and heating the heat generation portion.

### PRIOR ART DOCUMENT

### Patent Document

Patent Document 1: Japanese Patent Application Laid-Open (kokai) No. 2013-126844

### SUMMARY OF THE INVENTION

### Problem to be Solved by the Invention

Here, for achieving size reduction of the liquid heating device, the ceramic heater needs to be downsized. However, if the ceramic heater is downsized, the distance between the pair of heater terminals is also shortened, so that the heater terminals might contact with each other and be short-circuited.

Accordingly, an object of the present invention is to provide a liquid heating device in which size reduction is achieved and short-circuit between a pair of heater terminals of a ceramic heater is prevented.

### Means for Solving the Problem

In order to solve the above problem, a liquid heating device of a first aspect of the present invention is a liquid heating device comprising: a container having an internal space, and an inlet and an outlet communicating with the internal space; three or more ceramic heaters which extend in a front-rear direction and of which distal-end portions are located in the internal space and base-end portions are located outside the container, the ceramic heaters each having a heat generation portion at the distal-end portion and a pair of heater terminals at the base-end portion; and a separator opposed to the container and having a retention portion surrounding at least a part of each heater terminal of the pairs of heater terminals, to restrict positions of the heater terminals, wherein in a process in which a liquid is introduced from the inlet and flows through the internal space to the outlet, the liquid is heated by the ceramic heaters, the ceramic heaters are arranged side by side with each other along the front-rear direction, and in a cross-section crossing the front-rear direction, centers of gravity of a plurality of the ceramic heaters are respectively located at vertices of a polygon, a first heater terminal which is one of the pair of heater terminals of each ceramic heater is located inside the polygon, and a second heater terminal which is another of the pair of heater terminals of each ceramic heater is located outside the polygon.

With this liquid heating device, in the liquid heating device having three or more multiple ceramic heaters, the pair of heater terminals of each ceramic heater are separated into the first heater terminal inside the polygon and the second heater terminal outside the polygon. Therefore, even if the ceramic heaters are downsized, the pair of heater terminals of each ceramic heater can be prevented from contacting with each other and being short-circuited.

A liquid heating device of a second aspect of the present invention is a liquid heating device comprising: a container having an internal space, and an inlet and an outlet communicating with the internal space; two or more ceramic heaters which extend in a front-rear direction and of which distal-end portions are located in the internal space and base-end portions are located outside the container, the ceramic heaters each having a heat generation portion at the distal-end portion and a pair of heater terminals at the base-end portion; and a separator surrounding at least a part of each heater terminal of the pairs of heater terminals, to restrict positions of the heater terminals, wherein in a process in which a liquid is introduced from the inlet and flows through the internal space to the outlet, the liquid is heated by the ceramic heaters, the ceramic heaters are arranged side by side with each other along the front-rear direction, and in a cross-section crossing the front-rear direction, centers of gravity of a plurality of the ceramic heaters are arranged on the same line, a first heater terminal which is one of the pair of heater terminals of each ceramic heater is located on one side across the same line, and a second heater terminal which is another of the pair of heater terminals of each ceramic heater is located on another side across the same line.

With this liquid heating device, in the liquid heating device having two or more multiple ceramic heaters, the pair of heater terminals of each ceramic heater are separated into the first heater terminal and the first heater terminal across the same line. Therefore, even if the ceramic heaters are downsized, the pair of heater terminals of each ceramic heater can be prevented from contacting with each other and being short-circuited.

In the liquid heating device according to the first aspect of the present invention, a distance D1 between the first heater terminal and the ceramic heater corresponding thereto may be smaller than a distance D2 between the second heater terminal and the ceramic heater corresponding thereto.

With this liquid heating device, each ceramic heater can be brought close to the first heater terminal side, i.e., the inner side, and therefore three or more ceramic heaters can be brought close to each other in the radial direction, whereby the liquid heating device can be downsized.

In the liquid heating device according to the first aspect of the present invention, at an opposing surface of the separator that faces the container, a taper may be provided around the retention portion surrounding the second heater terminal, such that the taper expands from the ceramic heater toward the retention portion along a direction in which the pair of heater terminals are arranged side by side, and leads to the retention portion.

Normally, the distances D1 and D2 of the ceramic heater are equal to each other, but when the pair of heater terminals are inserted into the retention portions of the separator, the distal end of the second heater terminal contacts with the taper and is expanded outward by being guided along a slope surface of the taper, while passing through the retention portion.

Thus, without making the distance D1 smaller than the distance D2 for the ceramic heater in advance, it is possible to assuredly make the distance D1 smaller than the distance D2 by using the taper as a guide when attaching the separator.

In the liquid heating device according to the first aspect of the present invention, the first heater terminals of a plurality of the ceramic heaters all may have the same potential, and all distances D3 between the first heater terminals adjacent to each other may be smaller than all distances D4 between the second heater terminals adjacent to each other.

Normally, in order to prevent discharge short-circuit, the distance between heater terminals adjacent to each other and not having the same potential is prescribed to be not less than a predetermined value (e.g., 3 mm in a spatial distance). Accordingly, if all the first heater terminals 18a have the same potential, the distance D3 between the first heater terminals adjacent to each other can be shortened and therefore the ceramic heaters can be brought close to each other in the radial direction, whereby the liquid heating device can be downsized.

In the liquid heating device according to the second aspect of the present invention, the first heater terminals or the second heater terminals of a plurality of the ceramic heaters all may have the same potential, all distances D3 between the heater terminals adjacent to each other and having the same potential may be smaller than all distances D4 between the heater terminals adjacent to each other and not having the same potential.

Normally, in order to prevent discharge short-circuit, the distance between heater terminals adjacent to each other and not having the same potential is prescribed to be not less than a predetermined value (e.g., 3 mm in a spatial distance). Accordingly, if all the first heater terminals 18a have the same potential, the distance D3 between the first heater terminals adjacent to each other can be shortened and therefore the ceramic heaters can be brought close to each other in the radial direction, whereby the liquid heating device can be downsized.

### Advantageous Effects of the Invention

According to the present invention, there can be obtained a liquid heating device in which size reduction is achieved and short-circuit between a pair of heater terminals of a ceramic heater is prevented.

### BRIEF DESCRIPTION OF THE DRAWINGS

FIG. 1 Perspective view showing the outer appearance of a liquid heating device according to an embodiment of a first aspect of the present invention.

FIG. 2 Exploded perspective view of the liquid heating device.

FIG. 3 Sectional view along line A-A in FIG. 1.

FIG. 4 Perspective view showing the outer appearance of a ceramic heater.

FIG. 5 Exploded perspective view showing the configuration of the ceramic heater.

FIG. 6 Perspective view showing the configuration of a separator.

FIG. 7 Sectional view showing arrangement of lead terminals in the separator.

FIG. 8 Perspective view showing a separator in a modification.

FIG. 9 Partial sectional view of the liquid heating device having the separator shown in FIG. 8.

FIG. 10 Sectional view showing still another modification of the first embodiment.

FIG. 11 Perspective view showing the outer appearance of a liquid heating device according to an embodiment of a second aspect of the present invention.

FIG. 12 Exploded perspective view of the liquid heating device according to the embodiment of the second aspect of the present invention.

FIG. 13 Sectional view showing arrangement of lead terminals in a separator, in the second embodiment.

FIG. 14 Sectional view showing a state in which first heater terminals have the same potential and a distance D3 is smaller than a distance D4 in FIG. 13.

FIG. 15 Sectional view showing a case where the liquid heating device according to the second embodiment of the present invention is applied to three ceramic heaters.

### MODES FOR CARRYING OUT THE INVENTION

Hereinafter, an embodiment of the present invention will be described.

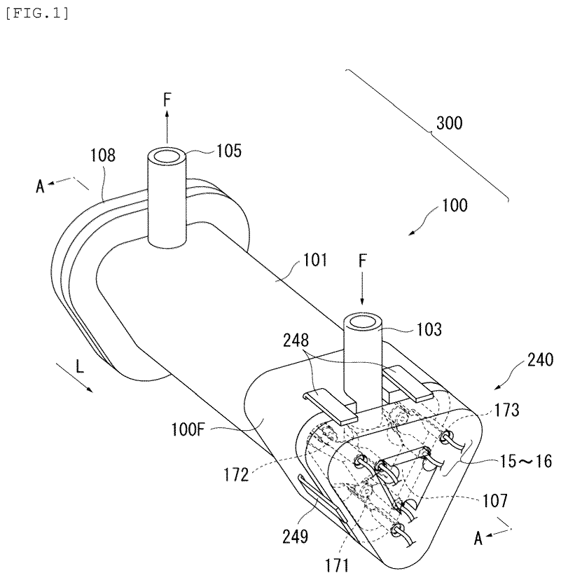

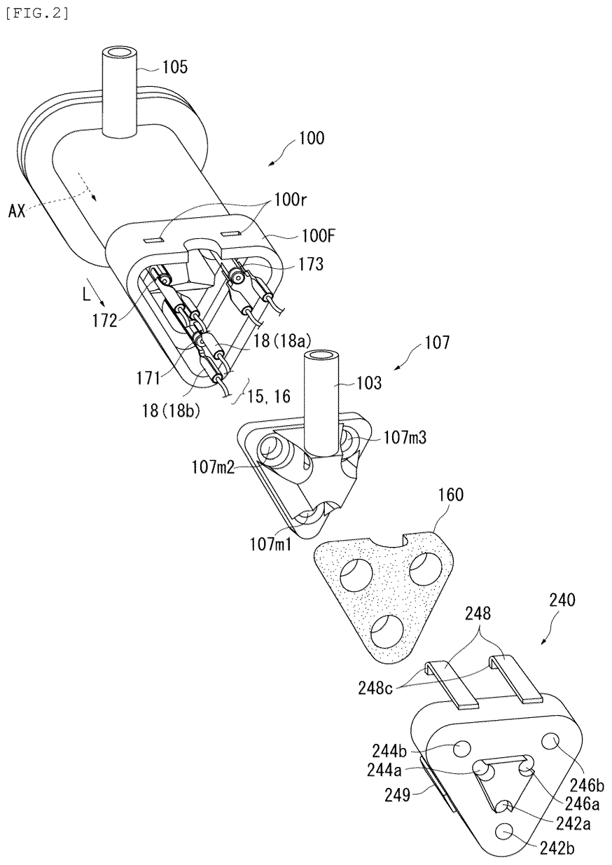

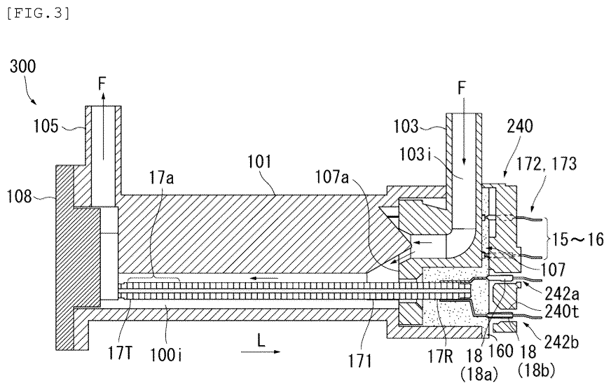

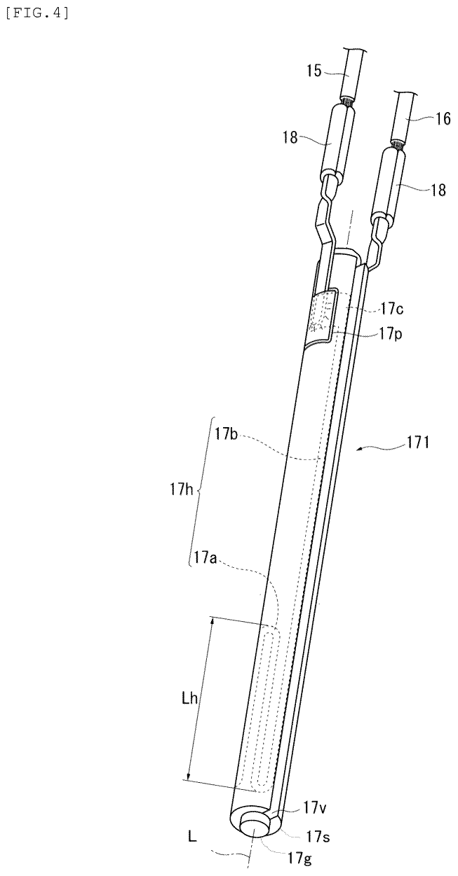

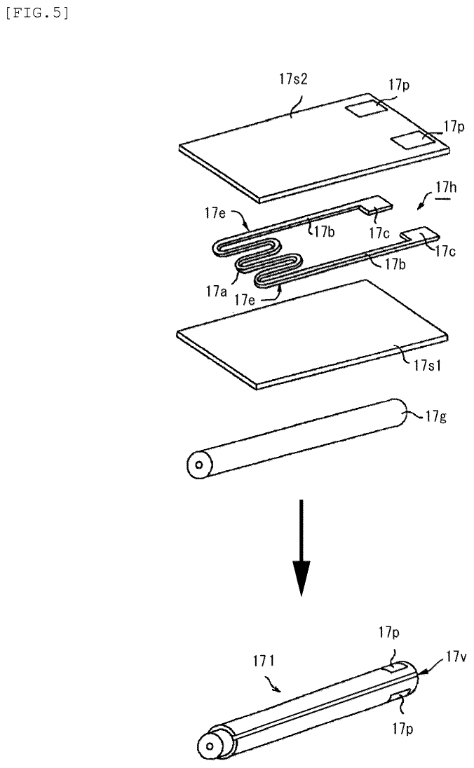

FIG. 1 is a perspective view of a liquid heating device 300 according to the embodiment of a first aspect of the present invention. FIG. 2 is a Exploded perspective view of the liquid heating device 300. FIG. 3 is a Sectional view along line A-A in FIG. 1. FIG. 4 is a perspective view showing the outer appearance of a ceramic heater 171. FIG. 5 is an exploded perspective view of the ceramic heater 171.

In this first embodiment, the liquid heating device 300 is provided to a warm water washing toilet seat, and heats ordinary-temperature water by three built-in ceramic heaters 171-173, to supply warm water.

As shown in FIG. 1, the liquid heating device 300 includes a container 100 having substantially a triangular tubular shape (a tubular shape whose cross-section is a triangle) in its entirety, the three ceramic heaters 171 to 173, and the separator 240.

The container 100 has an oblong tubular trunk portion 101 having an internal space 100i (FIG. 3) for storing a liquid (water), a front-end lid 107 and a rear-end lid 108 that close openings at both ends in the axial direction of the trunk portion 101, and an inlet 103 and the outlet 105 for the liquid W.

The inlet 103 and the outlet 105 are provided integrally with the front-end lid 107 and the trunk portion 101, respectively. The front-end lid 107 is fitted to a flange portion 100F at the front end in the axial-line-L direction of the trunk portion 101 (an end on a side where the ceramic heaters 171 to 173 are exposed).

At the rear end in the axial direction of the trunk portion 101, the rear-end lid 108 is sealed in a liquid-tight state via a rubber seal such as a packing, for example.

The three ceramic heaters 171 to 173 have rod shapes extending in a front-rear direction AX, and extend in the same direction (in parallel). Base-end portions 17R of the ceramic heaters 171 to 173 penetrate through three openings 107m1 to 107m3 of the front-end lid 107. Gaps between the ceramic heaters 171 to 173 and the openings 107m1 to 107m3 are sealed by a fixation member 160 made of epoxy resin, whereby the ceramic heaters 171 to 173 are fixed to the container 100 in a cantilever manner.

Thus, as shown in FIG. 3, a distal-end portion 17T of each ceramic heater 171 to 173 is located in the internal space 100i. Needless to say, the position of the fixation member 160 is on the base-end side relative to heat generation portions 17a of the ceramic heaters described later.

Lead wires 15, 16 described later for supplying power from outside are connected to the base-end portion 17R sides of the ceramic heaters 171 to 173.

In this example, the ceramic heaters 171 to 173 are stored in the internal space 100i of the trunk portion 101 such that the front-rear direction AX, i.e., the direction in which the ceramic heaters 171 to 173 are arranged side by side, is along the axial-line-L direction of the trunk portion 101.

The inlet 103 and the outlet 105 communicate with the internal space 100i and are located apart from each other in the axial-line-L direction. The liquid introduced through the inlet 103 from outside passes through the internal space 100i along the axial-line-L direction and then is discharged from the outlet 105.

A gap is formed between the inner wall of the container 100 and each ceramic heater 171 to 173. The liquid introduced into the internal space 100i through the inlet 103 contacts with the outer surfaces of the ceramic heaters 171 to 173 along the axial-line-L direction, thus being heated, and then the liquid flows to the outlet 105.

As shown in FIG. 2, the front-end lid 107 has a plate shape that is substantially triangular, and includes the three openings 107m1 to 107m3 and the inlet 103 extending outward from among the openings 107m1 to 107m3.

The three openings 107m1 to 107m3 are respectively located near the vertices of the triangle shape and form circular holes. The inlet 103 extends outward relative to the outer periphery of the front-end lid 107, along the plate surface from among the openings 107m1 to 107m3.

As shown in FIG. 3, an inner hole 1031 (flow path for liquid) of the inlet 103 is bent to be substantially perpendicular to the front-end lid 107 and opens at an inner surface 107a of the front-end lid 107.

The fixation member 160 made of epoxy resin is provided so as to not only fill the gaps between the ceramic heaters 171 to 173 and the openings 107m1 to 107m3 but also bury the front-end lid 107.

While the ceramic heaters 171 to 173 are buried with the fixation member 160 as described above, lead terminals 18 (18a, 18b) described later and the lead wires 15, 16 protrude outward relative to the fixation member 160 (rightward in FIG. 3).

The separator 240 will be described later.

Next, with reference to FIG. 4 and FIG. 5, the configuration of the ceramic heater will be described. The ceramic heaters 171 to 173 have the same shape and therefore the ceramic heater 171 will be described.

As shown in FIG. 4, the ceramic heater 171 has a heat generation body 17h which generates heat by being energized from outside via the lead wires 15, 16. The heat generation body 17h has, on the front-end side, the heat generation portion 17a formed by meandering a conductor in the front-rear direction L as a heat generation pattern, and has a pair of lead portions 17b led from both ends of the heat generation portion 17a to the rear-end side.

The heat generation portion 17a has a length of Lh in the front-rear direction L.

More specifically, as shown in FIG. 5, the heat generation body 17h has the heat generation portion 17a, both lead portions 17b, and electrode patterns 17c formed at rear ends of both lead portions 17b, and the heat generation body 17h is held between two ceramic green sheets 17s1, 17s2. As the ceramic green sheets, alumina is used. As the heat generation portion 17a and the lead portions 17b, tungsten, rhenium, or the like is used. Two electrode pads 17p to which a pair of lead terminals 18 (see FIG. 4) are to be brazed are formed on the front surface of the ceramic green sheet 17s2, and the electrode patterns 17c are connected to the electrode pads 17p via through holes, thus forming a laminated body of the ceramic green sheets.

Further, this laminated body is wrapped around a rod-shaped ceramic base 17g mainly composed of alumina, etc., with the ceramic green sheet 17s2 set on the front side, and then these are sintered, whereby the ceramic green sheets 17s1, 17s2 form a ceramic sheet 17s wrapped around the outer circumference of the ceramic base 17g so as to be integrated and thus the ceramic heater 171 can be produced.

The lead wires 15, 16 are crimped with the lead terminals 18 so as to be electrically connected thereto (see FIG. 4).

In this example, the ceramic base 17g is solid, but may have a tubular shape. In a case of a tubular shape, it is desirable to make sealing with resin or the like so as not to leak water from the through hole.

Here, in wrapping the laminated body around the ceramic base 17g, the laminated body is wrapped such that both ends along the front-rear direction L of the laminated body are spaced from each other. Thus, at a wrap-meeting part on the outer surface of the ceramic heater 171, a slit 17v forming a recessed groove along the front-rear direction L is formed as a non-heat generation portion.

Next, returning to FIG. 1 to FIG. 3, the separator 240 will be described.

As shown in FIG. 1, the separator 240 is attached to the flange portion 100F so as to cover the fixation member 160. Specifically, as shown in FIG. 2, a total of six retention portions 242a to 244a and 242b to 244b forming openings are provided in the separator 240. The three ceramic heaters 171 to 173 have a total of six lead terminals 18, and the lead terminals 18 are respectively inserted into the retention portions 242a to 244a and 242b to 244b. Thus, the radial-direction positions (movements) of the lead terminals 18 are restricted and the lead terminals 18 are retained by the separator 240.

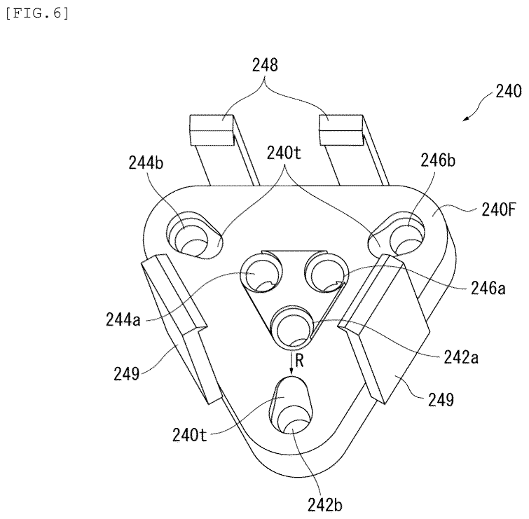

As shown in FIG. 6, the separator 240 has a plate shape that is substantially triangular, and three retention portions 242a, 244a, 246a are respectively located near the vertices of the triangular shape and form circular holes. The other three retention portions 242b, 244b, 246b are respectively located near the vertices of the triangular shape so as to surround the retention portions 242a, 244a, 246a, and form circular holes.

Among the retention portions, the retention portions 242a, 242b are closest to each other, the retention portions 244a, 244b are closest to each other, and the retention portions 246a, 246b are closest to each other.

At a side line of the separator 240 that connects the retention portions 244b, 246b, two claw portions 248 extending toward the flange portion 100F side are formed integrally with the separator 240. Similarly, at each of a side line connecting the retention portions 242b, 246b and a side line connecting the retention portions 242b, 244b, one claw portion 249 extending toward the flange portion 100F side is formed integrally with the separator 240.

Distal ends 248c of the claw portions 248 are bent inward so that the distal ends 248c of the claw portions 248 are engaged with two recesses 100r provided at corresponding positions in the flange portion 100F. Similarly, the claw portions 249 are engaged with recesses (not shown) in the flange portion 100F. Thus, the separator 240 is fixed to the flange portion 100F.

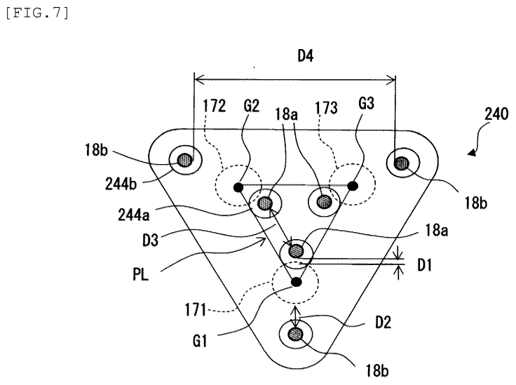

Next, with reference to FIG. 7, arrangement of the lead terminals 18 in the separator 240 will be described.

As shown in FIG. 7, in a cross-section crossing the front-rear direction AX (or the outer appearance of the separator 240 as seen from the right side in FIG. 1), centers of gravity G1 to G3 of the ceramic heaters 171 to 173 are respectively located at the vertices of a polygon (in this example, triangle) PL.

A total of three first heater terminals 18a each of which is one of the pair of heater terminals 18 of each ceramic heater 171 to 173 are located inside the polygon PL, and a total of three second heater terminals 18b each of which is the other of the pair of heater terminals 18 of each ceramic heater 171 to 173 are located outside the polygon PL.

As described above, in the liquid heating device 300 having three or more multiple ceramic heaters 171 to 173, the pair of heater terminals 18 of each ceramic heater are separated into the first heater terminal 18a inside the polygon PL and the first heater terminal 18b outside the polygon PL. Therefore, even if the ceramic heaters 171 to 173 are downsized, the pair of heater terminals 18a, 18b of each ceramic heater can be prevented from contacting with each other and being short-circuited.

In this example, a distance D1 between the first heater terminal 18a and the ceramic heater corresponding thereto is smaller than a distance D2 between the second heater terminal 18b and the ceramic heater corresponding thereto.

Thus, each ceramic heater can be brought close to the first heater terminal 18a side, i.e., the inner side, and therefore three or more ceramic heaters 171 to 173 can be brought close to each other in the radial direction, whereby the liquid heating device 300 can be downsized.

As shown in FIG. 6, in this example, at an opposing surface 240F of the separator 240 that faces the container 100 side, a taper 240t is provided around the retention portion 242b surrounding the second heater terminal 18b, such that the taper 240t expands from the ceramic heater 171 toward the retention portion 242b along a direction R in which the pair of heater terminals 18 are arranged side by side, and leads to the retention portion 242b. Similarly, tapers 240t lead to the retention portions 244b, 246b.

Normally, the distances D1 and D2 of the ceramic heater are equal to each other, but when the pair of heater terminals 18 are inserted into the retention portions 242a, 242b of the separator 240, the distal end of the second heater terminal 18b contacts with the taper 240t and is expanded outward by being guided along a slope surface of the taper 240t, while passing through the retention portion 242b.

Thus, without making the distance D1 smaller than the distance D2 for the ceramic heater in advance, it is possible to assuredly make the distance D1 smaller than the distance D2 by using the taper 240t as a guide when attaching the separator 240.

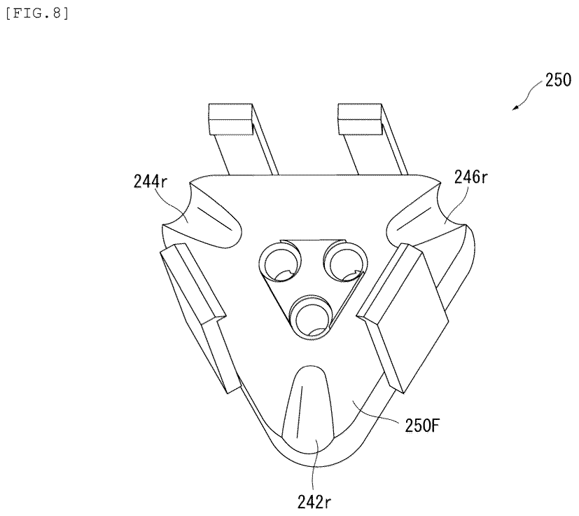

FIG. 8 is a perspective view showing a separator 250 in a modification. The separator 250 is different from the separator 240 in that retention portions 242r, 244r, 246r surrounding the second heater terminals 18b are not through holes but are grooves recessed from an opposing surface 250F facing the container 100 side.

Even in a case of such grooves, the second heater terminals 18b are retained around the outer surfaces of the grooves and are restricted at predetermined positions, and thus the grooves serve as retention portions.

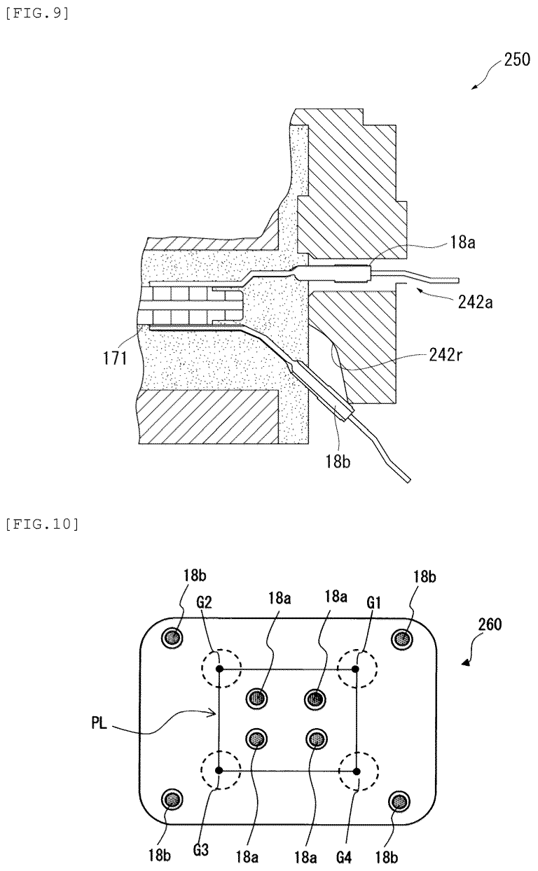

However, as shown in FIG. 9, each groove needs to lead to the outer periphery of the separator 250. Thus, the second heater terminal 18b or the lead wire connected thereto can be led from the outer periphery of the separator 250 to outside.

FIG. 10 is a sectional view showing still another modification of the first embodiment, and corresponds to FIG. 7.

As shown in FIG. 10, also in a liquid heating device having four ceramic heaters, in a cross-section crossing the front-rear direction AX, centers of gravity G1 to G4 of the ceramic heaters are respectively located at the vertices of a polygon (in this example, quadrangle) PL. The pair of heater terminals 18 of each ceramic heater are restricted by the respective retention portions of the separator 260 and are separated into the first heater terminal 18a inside the polygon PL and the first heater terminal 18b outside the polygon PL. The pair of heater terminals 18a, 18b of each ceramic heater can be prevented from contacting with each other and being short-circuited.

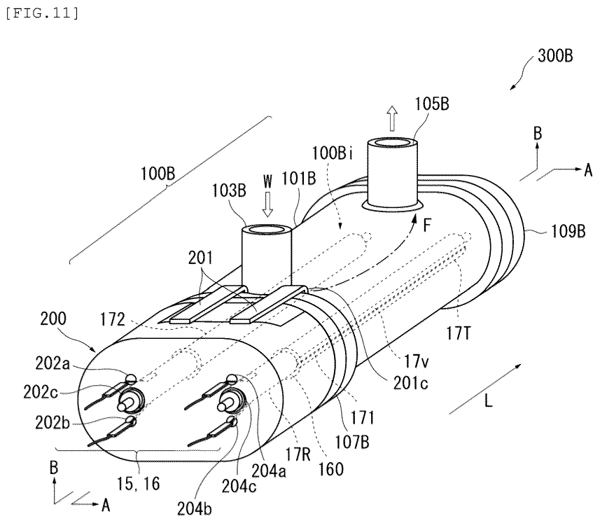

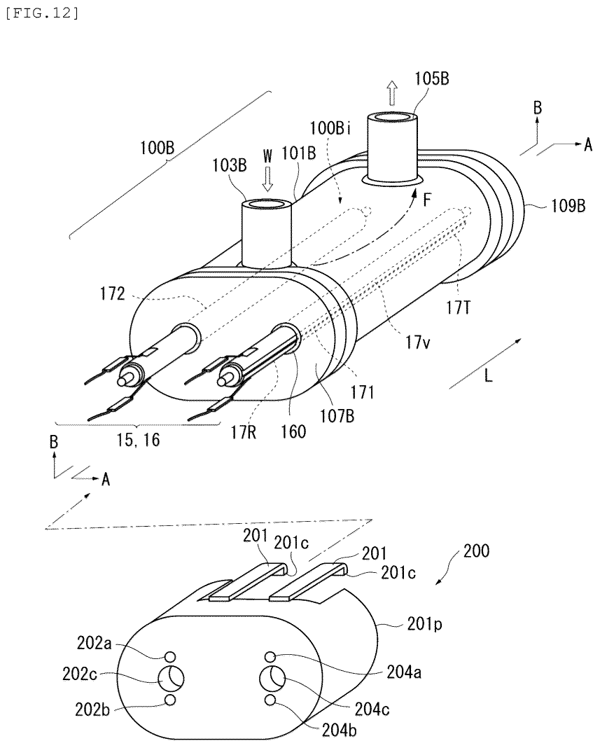

Next, with reference to FIG. 11 and FIG. 12, a liquid heating device 300B according to the second embodiment of the present invention will be described.

FIG. 11 is a perspective view showing the outer appearance of a liquid heating device 300B. FIG. 12 is an exploded perspective view of the liquid heating device 300B.

The liquid heating device 300B has two ceramic heaters 171, 172 and a separator 200, and the configurations of a container 100B and the separator 200 are different from the first embodiment. Other than this, the liquid heating device 300B is the same as the liquid heating device 300 according to the first embodiment and therefore the same components as those of the liquid heating device 300 are denoted by the same reference characters and the description thereof is omitted.

The liquid heating device 300B has substantially an oblong tubular shape (a tubular shape whose cross-section is a rectangle with rounded corners) extending in the axial-line-L direction in its entirety, and has the container 100B, the two ceramic heaters 171, 172, and the separator 200.

The container 100B has an oblong tubular trunk portion 101B having an internal space 100Bi for storing a liquid (water), a front-end lid 107B and a rear-end lid 109B that close openings at both ends in the axial direction of the trunk portion 101B, and an inlet 103B and the outlet 105B for the liquid which are provided integrally with the trunk portion 101B.

Both ends of the trunk portion 101B, and the front-end lid 107B and the rear-end lid 109B, are respectively sealed with each other in an airtight state by O rings 190 (not shown).

The ceramic heaters 171, 172 have rod shapes extending in the front-rear direction AX, and are arranged side by side toward the same direction (in parallel) along the front-rear direction AX. A base-end portion 17R of each ceramic heater 171, 172 is retained in a cantilever manner by a sealing portion 160 at an opening of the front-end lid 107B of the container 100B, whereby each ceramic heater 171, 172 is attached to the container 100B.

As in the case of the liquid heating device 300, a gap is formed between the inner wall of the container 100B and each ceramic heater 171, 172. A liquid introduced into the internal space 100i through the inlet 103B contacts with the outer surfaces of the ceramic heaters 171, 172 along the axial-line-L direction, thus being heated, and then the liquid flows to the outlet 105B.

Next, the separator 200 will be described.

As shown in FIG. 11, the separator 200 is attached to the container 100B so as to cover the front-end lid 107B. Specifically, as shown in FIG. 12, the separator 200 has a total of four retention portions 202a, 204a, 202b, 204b that form openings. A heater hole 202c for passing the rear end of the ceramic heater 172 is provided between the retention portions 202a, 202b. Similarly, a heater hole 204c for passing the rear end of the ceramic heater 171 is provided between the retention portions 204a, 204b.

The two ceramic heaters 171, 172 have a total of four lead terminals 18, and the lead terminals 18 are respectively inserted into the retention portions 202a, 204a, 202b, 204b. Thus, the radial-direction positions (movements) of the lead terminals 18 are restricted and the lead terminals 18 are retained by the separator 200.

As shown in FIG. 12, the separator 200 has a plate shape that is substantially oval, and two retention portions 202a, 202b are arranged along the minor axis of the separator 200 and form circular holes. The heater hole 202c is provided between the retention portions 202a, 202b. Similarly, two retention portions 204a, 2042b are arranged along the minor axis and the heater hole 204c is provided between the retention portions 202a, 202b.

At an upper side line along the major axis of the separator 200, two claw portions 201 extending toward the container 100B side are formed integrally with the separator 200. At both side lines along the minor axis of the separator 200, protrusions 201p extending toward the container 100B side are formed integrally with the separator 200.

Distal ends 201c of the claw portions 201 are bent inward so as to be engaged with a flange of the container 100B. When the claw portions 201 are engaged with the container 100B, the protrusions 201p contact with the container 100B. Thus, the separator 200 is fixed to the container 100B.

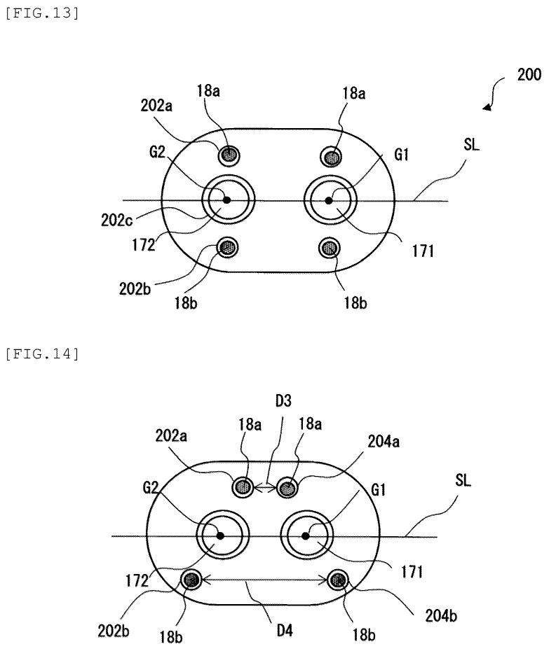

Next, with reference to FIG. 13, arrangement of the lead terminals 18 in the separator 200 will be described.

As shown in FIG. 13, in a cross-section crossing the front-rear direction AX (or the outer appearance of the separator 200 as seen from the left side in FIG. 11), centers of gravity G1, G2 of the ceramic heaters 171, 172 are arranged on the same line SL.

A total of two first heater terminals 18a each of which is one of the pair of heater terminals 18 of each ceramic heater 171, 172 are located on one side across the same line SL, and a total of two second heater terminals 18b each of which is the other of the pair of heater terminals 18 of each ceramic heater 171, 172 are located on the other side across the same line SL.

As described above, in the liquid heating device 300 having two or more multiple ceramic heaters 171, 172, the pair of heater terminals 18 of each ceramic heater are separated into the first heater terminal 18a and the first heater terminal 18b across the same line SL. Therefore, even if the ceramic heaters 171, 172 are downsized, the pair of heater terminals 18a, 18b of each ceramic heater can be prevented from contacting with each other and being short-circuited.

In the second embodiment of the present invention, as shown in FIG. 14, the first heater terminals 18a of all the ceramic heaters 171, 172 may have the same potential, and a distance D3 between the heater terminals 18a adjacent to each other and having the same potential may be smaller than a distance D4 between the heater terminals (second heater terminals 18b) adjacent to each other and not having the same potential.

Normally, in order to prevent discharge short-circuit, the distance between heater terminals adjacent to each other and not having the same potential is prescribed to be not less than a predetermined value (e. g., 3 mm in a spatial distance).

Accordingly, if all the first heater terminals 18a have the same potential, the distance D3 between the first heater terminals 18a adjacent to each other can be shortened and therefore the ceramic heaters 171, 172 can be brought close to each other in the radial direction, whereby the liquid heating device 300B can be downsized.

Normally, the same potential is a ground potential. In the second embodiment, the first heater terminals 18a may have the same potential or the second heater terminals 18b may have the same potential.

In the ceramic heaters 171, 172, the first heater terminals 18a all have the same potential characteristic (e.g., the ground potential side) and also the second heater terminals 18 all have the same potential characteristic (e.g., the application potential side).

It should be understood that the present invention is not limited to the above embodiments and incorporates various modifications and equivalents within the idea and the scope of the present invention.

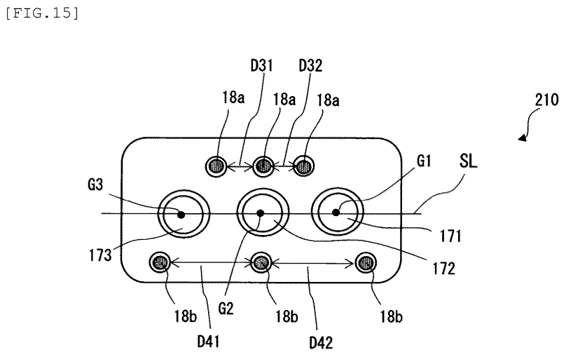

For example, as shown in FIG. 15, in the second embodiment, as long as the centers of gravity are arranged on the same line SL, three or more ceramic heaters 171 to 173 may be placed in a separator 210. In this case, as in the case of FIG. 14, the first heater terminals 18a of all the ceramic heaters 171 to 173 may have the same potential, and distances D31, D32 therebetween may be smaller than distances D41, D42 between the heater terminals (second heater terminals 18b) adjacent to each other and not having the same potential.

In a case where each of the number of the heater terminals 18a having the same potential and the number of the heater terminals 18b not having the same potential is three or more, the distances D31, D32 between all the heater terminals 18a adjacent to each other are considered as the distance D3, and the distances D41, D42 between all the heater terminals 18b adjacent to each other are considered as the distance D4.

Then, all the distances D31, D32 need to be smaller than all the distances D41, D42. Specifically, regarding all combinations of D3 and D4, D31<D41, D32<D41, D31<D42, and D32<D42 need to be satisfied.

In the first embodiment, the first heater terminals 18a inside the polygon PL may have the same potential, and the distance D3 between the first heater terminals 18a adjacent to each other may be smaller than the distance D4 between the second heater terminals 18b adjacent to each other.

### DESCRIPTION OF REFERENCE NUMERALS

17a heat generation portion
17T distal-end portion of ceramic heater
17R base-end portion of ceramic heater
18, 18a heater terminal (first heater terminal)
18, 18b heater terminal (second heater terminal)
100,100B container
100,100Bi internal space
101r, 101Br1, 101Br2 recess
103,103B inlet
105,105B outlet
171-174 ceramic heater
200,210,240,250,260 separator
202a,204a,202b,204b,242a-246a,242b-246b,242r-246r retention portion
240F,250F opposing surface
240t taper
300,300B liquid heating device
AX front-rear direction
G1-G4 center of gravity
PL polygon
SL same line

1. A liquid heating device comprising:
a container having an internal space, and an inlet and an outlet communicating with the internal space;
three or more ceramic heaters which extend in a front-rear direction and of which distal-end portions are located in the internal space and base-end portions are located outside the container, the ceramic heaters each having a heat generation portion at the distal-end portion and a pair of heater terminals at the base-end portion; and
a separator opposed to the container and having a retention portion surrounding at least a part of each heater terminal of the pairs of heater terminals, to restrict positions of the heater terminals, wherein
in a process in which a liquid is introduced from the inlet and flows through the internal space to the outlet, the liquid is heated by the ceramic heaters,
the ceramic heaters are arranged side by side with each other along the front-rear direction, and
in a cross-section crossing the front-rear direction, centers of gravity of a plurality of the ceramic heaters are respectively located at vertices of a polygon, a first heater terminal which is one of the pair of heater terminals of each ceramic heater is located inside the polygon, and a second heater terminal which is another of the pair of heater terminals of each ceramic heater is located outside the polygon.

2. A liquid heating device comprising:
a container having an internal space, and an inlet and an outlet communicating with the internal space;
two or more ceramic heaters which extend in a front-rear direction and of which distal-end portions are located in the internal space and base-end portions are located outside the container, the ceramic heaters each having a heat generation portion at the distal-end portion and a pair of heater terminals at the base-end portion; and
a separator surrounding at least a part of each heater terminal of the pairs of heater terminals, to restrict positions of the heater terminals, wherein
in a process in which a liquid is introduced from the inlet and flows through the internal space to the outlet, the liquid is heated by the ceramic heaters,
the ceramic heaters are arranged side by side with each other along the front-rear direction, and
in a cross-section crossing the front-rear direction, centers of gravity of a plurality of the ceramic heaters are arranged on the same line, a first heater terminal which is one of the pair of heater terminals of each ceramic heater is located on one side across the same line, and a second heater terminal which is another of the pair of heater terminals of each ceramic heater is located on another side across the same line.

3. The liquid heating device according to claim 1, wherein
a distance D1 between the first heater terminal and the ceramic heater corresponding thereto is smaller than a distance D2 between the second heater terminal and the ceramic heater corresponding thereto.

4. The liquid heating device according to claim 3, wherein
at an opposing surface of the separator that faces the container, a taper is provided around the retention portion surrounding the second heater terminal, such that the taper expands from the ceramic heater toward the retention portion along a direction in which the pair of heater terminals are arranged side by side, and leads to the retention portion.

5. The liquid heating device according to claim 1, wherein
the first heater terminals of a plurality of the ceramic heaters all have the same potential, and all distances D3 between the first heater terminals adjacent to each other are smaller than all distances D4 between the second heater terminals adjacent to each other.

6. The liquid heating device according to claim 2, wherein
the first heater terminals or the second heater terminals of a plurality of the ceramic heaters all have the same potential, all distances D3 between the heater terminals adjacent to each other and having the same potential are smaller than all distances D4 between the heater terminals adjacent to each other and not having the same potential.
